(19) United States
(12) Patent Application Publication
(10) Pub. No.: US 2007/0173991 A1
(43) Pub. Date: Jul. 26, 2007

(54) System and method for identifying undesired vehicle events

(76) Inventors: Stephen Tenzer, Prior Lake, MN (US); Benjamin J. Nielsen, Lakeville, MN (US); Jon Passman, Minnetonka, MN (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/337,888

(22) Filed: Jan. 23, 2006

(51) Int. Cl. G06F 19/00

(52) U.S. Cl. 701/29; 340/438

(57) ABSTRACT

A method for assessing the undesired use of vehicles within a fleet is described. At least one exception is defined relating to the use of vehicles within the fleet, wherein the exception is selected from the group of safety exceptions, maintenance exceptions, legal compliance exceptions, and unauthorized use exceptions. Data is received relating to the use of each vehicle within the fleet. The at least one exception is then applied to the data for each vehicle and it is determined whether any defined exceptions have occurred. A statistical metric is determined representative of the undesired use of the vehicles within the fleet based upon the defined exceptions.

### FIELD OF THE INVENTION

This invention relates to a system and method for identifying undesired vehicle events that may occur to vehicles within a fleet of vehicles.

### BACKGROUND OF THE INVENTION

Vehicles in a fleet of vehicles are subject to many different types of undesirable uses that can be detrimental to the owner of a fleet, the vehicles in the fleet, or the operator of a fleet vehicle. These undesirable uses can affect the safety of the vehicle and operator of the vehicle, the condition of the vehicle, the efficient use of the vehicle, and the legality of the use of a vehicle. For example, some vehicles within a fleet may be driven at excessive speed, which increases risk to the safety of the vehicle and operator of the vehicle, as well as causing the vehicle to inefficiently use fuel. By way of further example, fleet vehicles may be driven in deviation from an optimized and authorized route or otherwise be used outside of the authorized time frame of use for the vehicle. This use increases wear to the vehicle, increases fuel costs for the vehicle, reduces resale value for the vehicles, and may impact the ability of a vehicle to meet its schedule. In another example, a fleet vehicle may be driven without proper legal authorization, such as if a vehicle does not have valid registration tags or inspection tags. That usage subjects the vehicle to potential fines and also delays in meeting its schedule if the vehicle is stopped for a lack of meeting a legal compliance requirement. In one other example, a vehicle may be driven when it is in need of schedule maintenance or while a malfunction indicator light is on in the vehicle. Among other things, this usage endangers the longevity of the vehicle.

Conventional fleet systems that analyze the use of vehicles within a fleet are generally limited to analyzing basic usage parameters of a vehicle based upon sensor readings that are made on the vehicle. Thus, a conventional system may measure basic parameters such as the speed of the vehicle or the location of a vehicle. Although such systems are useful, users may desire enhanced vehicle analysis systems and methods that include the use of statistical metrics to identify specific vehicles within a fleet that display a propensity towards undesired events. In addition, users may desire enhanced vehicle analysis systems and methods that operate within the framework of an integrated fleet system that includes a fleet management application, a scheduling application, a routing application, a diagnostic application, and a location device. The use of data from these other aspects of the integrated system, and not just data from vehicle sensors, enables the use of an enhanced system and method for vehicle use analysis.

Accordingly, there is a need for a system and method for identifying undesired vehicle events within the framework of an integrated fleet system so that a fleet owner can better analyze and stop the occurrence of undesired events involving fleet vehicles.

### SUMMARY OF THE INVENTION

Accordingly, the present invention is directed to a system and method of using information on the operation of individual vehicles within a fleet to identify undesired use of vehicles within a fleet. This system and method substantially obviates one or more of the problems due to limitations and disadvantages of the related art.

An object of the present invention is to provide a system and method of identifying undesired use of fleet vehicles using a statistical metric, thereby enabling a fleet owner to adopt policies to prevent the undesired use. An object of the present invention is to provide a system and method of analyzing an individual vehicle to identify undesired use of fleet vehicles within the context of an integrated system, which allows enhanced analysis of the use of fleet vehicles.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### DESCRIPTION OF DRAWINGS

FIG. 1 is a block diagram representation of a system for identifying undesired use of vehicles in a fleet of vehicles in an embodiment of the present invention.

FIG. 2 is a flowchart of steps in one embodiment of the method of identifying undesired use of vehicles in a fleet of vehicles.

### DETAILED DESCRIPTION OF THE PREFERRED EMBODIMENTS

Reference will now be made in detail to an embodiment of the present invention, example of which is illustrated in the accompanying drawings.

The present invention provides a system and method for applying exceptions for assessing the undesired use of vehicles in a fleet, in which the system is an integrated system that incorporates various modules working together to enable the application of the exceptions.

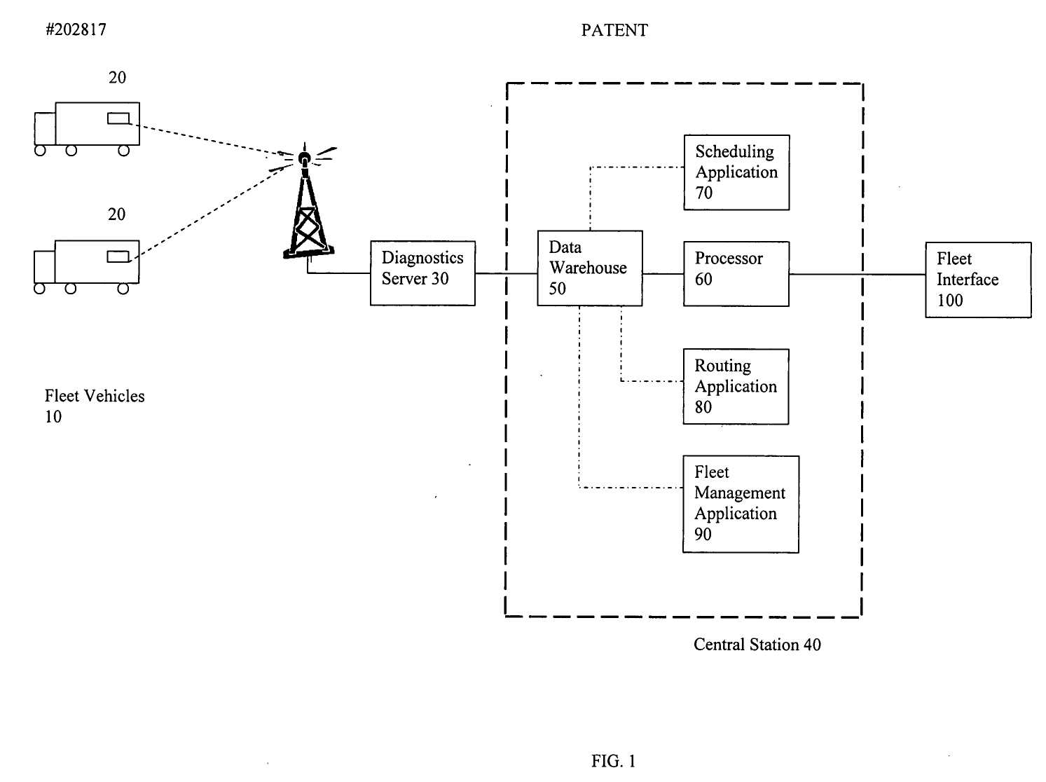

FIG. 1 depicts a system that can be used to practice the method of the invention. The system comprises a central station 40 that can include a processor 60 for processing data and a data warehouse 50 for storing data. The data stored in the data warehouse 50 can include data received from other applications used within fleets, such as a scheduling module 70, routing module 80, and a fleet management module 90. The system may also include a fleet interface 100 through which a fleet owner can access data processed by the central station 40. The fleet interface 100 may be part of the central station 40 in configurations where the central station 40 is owned and operated by the fleet owner. In another embodiment, the central station 40 is owned and operated by a fleet services provider who compiles and processes fleet data and makes it available to a fleet owner through the fleet interface 100. Data warehouse 50 is linked to a diagnostics server 30 or diagnostics computer that receives diagnostics information from fleet vehicles 10. The diagnostics server 30 processes the data it receives from fleet vehicles 10 and sends preprocessed data to the data warehouse 50. This advantageous configuration gives a fleet owner the flexibility to use third party diagnostics providers as part of its integrated fleet solution.

Vehicles include a mobile device 20 that obtains raw data concerning use conditions on the vehicle. The use conditions are various operating conditions of the vehicle, such as the speed of the vehicle, whether a malfunction indicator light is on in the vehicle, diagnostic trouble codes, odometer, fuel consumed, and the operating temperature of the engine. These conditions can be obtained from an existing on board diagnostic (OBD) system already on the vehicle, which exists on every current vehicle. In one embodiment, these use conditions are accessed through an OBD connector already on the vehicle, to which the mobile device is connected. In another embodiment, the mobile device is connected to the OBD system through other means such as a hardwire connection to the OBD system.

The mobile device 20 on the fleet vehicle 10 includes a transmitter or transceiver that is used to transmit the raw OBD data obtained by the mobile device 20 to a diagnostics server 30. The transmitter can be any type of transmitter capable of wirelessly transmitting the raw data to a remote location, including a satellite based system or cellular based system.

The mobile device 20 may also include or be linked to a locating device on the vehicle that determines the location of the vehicle. The geographical location can be obtained by a variety of methods, including a locator that uses a position determining system, such as the Global Positioning System (GPS), Differential GPS (DGPS), Eurofix DGPS, and the Global Navigation Satellite System (GLONASS). Importantly, the present invention is well-suited to use any position determining system (both terrestrial and satellite based) as well as future systems that may be developed, and is not dependent on the use of a particular system. In one embodiment, the locating device on the vehicle can be completely separate from the diagnostics system, and have its own wireless communications means to transmit location information to the central station 40.

In the present invention, the mobile device 20 transmits the raw OBD data to a diagnostics server 30 that is configured to receive raw OBD data from fleet vehicles. The diagnostics server 30 typically processes the raw data to calculate specific parameters from the data. The diagnostics server 30 may also process the raw data to reduce the amount of total data. The type of preprocessing performed by the diagnostics server includes determining fuel consumption, location information speed, odometer, fuel economy, emissions status (meeting emissions regulations), ignition status, MIL (Malfunction Indicator Light) status, and other types of processing.

After the diagnostics server 30 has processed the raw data, it transmits that processed data to a data warehouse 50 via a linkage between the diagnostics server 30 and the data warehouse 50. Linkage between the diagnostics server 30 and the data warehouse 50 may be through a communications network (which may a wired or wireless LAN, WAN, internet, extranet, peer-to-peer network, cellular or satellite transmission network), or through other such devices that allow for the transmission of information between the diagnostics server 30 and the data warehouse 50.

The data warehouse 50 is typically located at a central station 40 where the preprocessed data received from the diagnostics server may be stored. Data warehouse 50 may comprise any type of device or devices that have storage, including servers or computers. These devices may be located at one facility such as a central station, but they also may be spread over multiple facilities and directly linked or linked through a network. Data warehouse 50 includes datasets or databases, of information that describes the operational conditions of individual vehicles during daily activities and may include at least one dataset describing operational characteristics of the fleet, or portions of the fleet. Operational data on individual vehicles may be processed data based on raw data from sensors on a vehicle, or calculated data derived from either raw or processed data. Examples of operational data may include, but is not limited to, vehicle speed, position of ignition switch, distance traveled, tire pressure, and fuel consumption.

In one embodiment, the data warehouse 50 is also linked to other fleet applications that are part of an integrated fleet solution. For example, data warehouse 50 may be linked to a scheduling module application 70 that provides schedules (both service and maintenance) for each vehicle in the fleet. Those schedules may be stored in the data warehouse 50 or otherwise linked to the data warehouse 50 for access by the operator of the central station (which may be a provider of fleet services or the fleet owner) for use with exceptions that need that information. Data warehouse 50 may also be linked to a routing module application 80 that determines optimized routes for each vehicle. Those routes may be stored in the data warehouse 50 or otherwise linked to the data warehouse 50 for access by the owner of the central station for use with exceptions that may need that information. In one embodiment, the routing information may be in the form of a geo-fence, or set of geo-fences, that define established travel routes. Data warehouse 50 may also be linked to a fleet management module or application 90 that contains legal compliance and general information concerning vehicles and vehicle operators. That information may be stored in the data warehouse 50 or otherwise linked to the data warehouse 50 for access by the operator of the central station for use with exceptions that need that information. This advantageous configuration gives an operator of the central station the flexibility to use third party scheduling, routing, or fleet management applications or providers as part of its integrated fleet solution.

The exceptions applied by the method and system of the invention can be applied by any of the processor in any of the computers or servers at the central station 40. The processor 60 can be part of the data warehouse 50, part of a separate applications processor, or it can be part of other computer equipment at the central station 40 or linked to the central station 40. The service provider, who is compiling and processing the information from the various applications at the central station 40 and making certain processed data available to the fleet owner through the fleet manager interface, can configure the central station 40 as desired to maximize efficiency and utilization of the equipment, and can choose which piece of equipment(s) will apply the exceptions. A computer or server chosen to apply the exceptions must simply be linked to the data warehouse 50 to obtain necessary data to allow the exceptions to be defined and applied.

Fleet interface 100 represents a desktop computer, a laptop computer, workstation, handheld device, server or other such device for interacting with the processor 60 and all of the applications that may be linked at the central station 40. Fleet interface 100 may be a web-based application that allows a fleet owner or operator to access the functions of the integrated fleet system, or it may be an application that is directly linked to the central station. Linkages between fleet interface 100 and the processor 60, and the processor 60 and the data warehouse 50 may be through a communications network (which may be a wired or wireless LAN, WAN, internet, extranet, peer-to-peer network, cellular or satellite transmission network), or through other such devices that allow for the transmission of information between the fleet interface 100 and the data warehouse 50.

Central station 40 can comprise a single computer/workstation, multiples computers/workstations, servers, routers, storage devices, and combinations thereof, in which certain of the equipment provides the function of the data warehouse 50, certain of the equipment may host the other applications (scheduling, routing, fleet management, and any other application that may be used within an integrated fleet management system), and certain of the equipment operates as the processor 60. In another embodiment, the other applications are provided by third party providers and are not within the central station, but provide the central station with data relating to those applications.

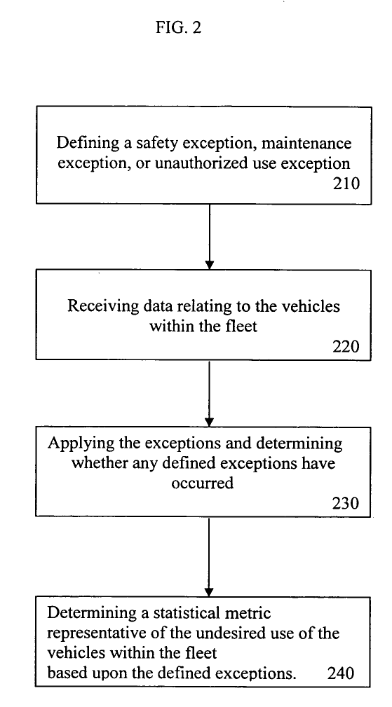

FIG. 2 depicts a flowchart summarizing one embodiment of the method of the present invention. At step 210, the central station operator (either a service provider or the fleet manager, if the fleet owner also owns the central station) defines at least one safety exception, one maintenance exception, and at least one unauthorized use exception. In one embodiment, the safety exception determines if a vehicle has been driven above a predetermined threshold speed, the maintenance exception determines whether a vehicle has been driven with a malfunction indicator light on in the vehicle, and the unauthorized use exception determines whether a vehicle has been driven outside of authorized times, such as after work hours. At step 220, the data warehouse 50 receives processed operational data from the diagnostics server 30. At step 230, the exceptions are applied to the processed data to determine whether exceptions have occurred. At step 240, a statistical metric representing the occurrence of undesired events in the fleet is determined. The definition and application of certain types of safety, maintenance, unauthorized use, legal compliance exceptions are discussed below.

Safety Exceptions

Safety exceptions may be defined that allow a fleet owner to monitor undesired use in terms of safety. For example, safety exceptions can be defined to identify operation of a vehicle at excessive speed, excessive acceleration, excessive braking, seat belt usage, too-frequent lane changing, tailgating, excessive speed in turns, and whether the vehicle has been in an accident(s). Exceptions relating to safety can help a fleet owner identify use of fleet vehicles that are potentially dangerous to the fleet vehicle and the operator. The undesired use of vehicles in an unsafe manner may also affect fuel economy of the vehicle and perception of a fleet by the public.

Certain of the safety exceptions can be defined 210 by setting threshold ranges or values representing desired use for each type of safety exception. For example, for a maximum speed exception, a maximum threshold speed or a range of allowed speeds can be set for vehicles within a fleet. If data relating to speed (or from which speed can be estimated) that was received from the vehicle indicates that the maximum speed was exceeded or that the speed was outside of the desired allowed speed range, an exception is generated. Similarly, for the excessive acceleration, excessive braking, too-frequent lane changing, tailgating, and excessive speed in turns safety exceptions, threshold values representing desired use can be set. For excessive acceleration, a threshold is set according to which use condition is used to monitor excessive acceleration. For example, in one embodiment, excessive acceleration can be monitored through use of an appropriate accelerometer in the vehicle, and a threshold can be set based on the scale used by the accelerometer. In another embodiment, excessive acceleration might be monitored though fuel usage, with spikes in fuel usage by a vehicle representing excessive acceleration; in that embodiment the excessive acceleration threshold might be expressed in terms of fuel usage. An appropriate threshold can be set depending on the use condition monitored. The excessive braking exception can be defined with a threshold relating to the number of times the brake pedal is pressed in a vehicle, or it could also be defined in relation to an appropriate accelerometer that can measure the braking force applied; the too-frequent lane changing exception can be defined with a threshold for an appropriate accelerometer that measures lateral motion of the vehicle; the excessive speed in turns can be defined with a threshold relating to speed (such as GPS readings from which speed can be determined, actual speed readings) and a threshold relating to the leaning of a vehicle as would happen in a turn, which could be measure with a sensor such as a three dimensional accelerometer.

Defining 210 safety exceptions for seat belt usage and whether the vehicle has been in accidents can involve a threshold value that relates to whether a seat belt is being used or whether the vehicle has been in an accident. For example, in the case of a seat belt threshold, the threshold can be a value relating to use of the seat belt. A vehicle typically may have a diagnostic code that indicates seatbelt use, and that code can be the threshold used for the exception. If the data received 220 from the vehicle through the diagnostics server indicates a code other than the code value for seat belt use, an exception is generated.

Defining 210 the safety exception for whether a vehicle has been in an accident can involve the use of a threshold value. In one embodiment, the safety exception for occurrence of an accident can be implemented by setting a threshold value of the number of accidents that have occurred with a vehicle. For example, a fleet owner may wish for an exception to be generated for any vehicle that has had two accidents. The accident exception would be applied 230 by receiving data 220 from a database that is linked to the central station 40 that indicates whether the vehicle has been in an accident, receiving data from the vehicle indicating that the vehicle is being used, then applying the exception. Significantly, in another embodiment, an accident exception can be advantageously implemented within an integrated system in which a fleet management system 90 containing information about accidents is integrated with a diagnostic system that obtains data from which it can be determined whether a vehicle is being used. This data would be received by the processor 60 that is applying an accident exception, which would compare the number of accidents for the vehicle with the threshold value set. Data from the vehicle that indicates the vehicle is being used can include speed data that indicates that the vehicle is moving, odometer data that indicates that the vehicle is moving, ignition on information that indicates that the vehicle is on, or any other data that can be used to determine that the vehicle is in use.

Maintenance Exceptions

Maintenance exceptions may be defined 210 that allow a fleet owner to monitor undesired use in terms of maintenance. For example, maintenance exceptions can be defined to identify operation of a vehicle while a warning indicator is on in the vehicle, operating a vehicle while a check engine light is on in the vehicle, or operating a vehicle for which scheduled maintenance is overdue. Exceptions relating to maintenance can help a fleet owner identify use of fleet vehicles that may damage the fleet vehicles. The use of vehicles requiring maintenance may also affect fuel economy and safety of a vehicle.

A maintenance exception can be defined 210 to compare maintenance schedules for a vehicle to data showing actual use of the vehicle. The maintenance schedules for each vehicle can be used to define the threshold date values of desired use. For example, if the maintenance schedule indicates that vehicle maintenance was due on March 31 but not performed, and the data received 220 from the vehicle through the diagnostics server 30 indicates that the vehicle is used on April 15, an exception for that vehicle is generated. A maintenance exception can also be defined 210 so that an exception is generated if a vehicle is used when a vehicle warning light is on relating to maintenance, such as a check engine light or low oil pressure light. If the data received 220 from the vehicle indicates that a warning light is on, and the data from the vehicle indicates that the vehicle is being used while the warning light is on, an exception for that vehicle is generated.

In one embodiment, a maintenance exception for use of the vehicle for which scheduled maintenance is overdue can be implemented by receiving maintenance schedule data relating to each vehicle from a database that is linked with the data warehouse 50, where the maintenance data is used to define the threshold value or range of values for the exception. Significantly, in another embodiment, a maintenance exception for use of the vehicle for which scheduled maintenance is overdue can be advantageously implemented within an integrated system in which a scheduling system 70 containing maintenance scheduling information is integrated with a diagnostic system that obtains data from which it can be determined whether a vehicle is being used. In such a system, the scheduling system 70 can include a maintenance schedule for each vehicle in the fleet. This data would be received by the processor 60 that is defining 210 a maintenance exception for use of the vehicle for which scheduled maintenance is overdue, which would then apply 230 an exception by comparing the schedule for each vehicle to data received 220 for each vehicle through the diagnostics server 30 relating to the date on which the vehicle is being used. Data from the vehicle that indicates the vehicle is being used and how can include speed data that indicates that the vehicle is moving, odometer data that indicates that the vehicle is moving, ignition on information that indicates that the vehicle is on, or any other data that can be used to determine that the vehicle is in use.

Unauthorized Use Exceptions

Exceptions relating to the unauthorized use of a fleet vehicle can help a fleet owner identify undesired use of fleet vehicles outside of authorized times, such as after work hours, or outside of authorized locations or routes. A separate exception can be implemented for unauthorized time use and unauthorized location use. Use of vehicles outside of authorized times and locations may subject vehicles to unnecessary wear and tear and also subjects those vehicles to added risk of accident. Use of vehicles outside of authorized times and locations may also affect the fuel consumption of the vehicle.

Each unauthorized use exception can be defined 210 to compare authorized use information relating to each vehicle to data relating to actual use of the vehicle. For example, if the data received 220 from the vehicle through the diagnostics server 30 indicates that the vehicle is being used at an unauthorized time, an exception for that vehicle is generated. Likewise, if an unauthorized location exception is used, if the data received 220 from the vehicle through the diagnostics server 30 indicates that the vehicle is being used in an unauthorized location or route, an exception for that vehicle is generated.

In one embodiment, unauthorized use exceptions can be implemented by storing scheduling or routing information relating to each vehicle in a database that is accessible by the processor 60. The schedules or routing information for each vehicle can be used to define 210 the threshold date values or routes of desired use for each vehicle. Significantly, unauthorized use exceptions can be advantageously implemented within an integrated system in which a scheduling 70 or routing 80 system containing scheduling information or route information is integrated with a diagnostic system that can determine a vehicle's location or the time at which it is being used. In such a system, the scheduling system can include a schedule for each vehicle in the fleet. This data would be used by the processor 60 that is defining 210 an unauthorized time-use exception, which would apply 230 the exception by comparing the schedule for each vehicle to data obtained from each vehicle relating to when the vehicle is being used. Data from the vehicle that indicates the vehicle is being used can include speed data that indicates that the vehicle is moving, odometer data that indicates that the vehicle is moving, ignition on information that indicates that the vehicle is on, or any other data that can be used to determine that the vehicle is in use. For an unauthorized location-use exception, the system can be advantageously integrated with a routing system that contains route information for each vehicle. This data would be used by the processor 60 that is defining an unauthorized location-use exception, which would compare the route for each vehicle to location data obtained from each vehicle. In one embodiment, the location-use exception can be implemented using geo-fences that define authorized routes and specific boundaries in which the vehicle is allowed to be used.

Legal Compliance Exceptions

Exceptions relating to the legal compliance status of a fleet vehicle can help a fleet owner identify undesired use of fleet vehicles that involve the use of a vehicle that is not in legal compliance. Examples of legal compliance exceptions that can be implemented include exceptions for operating a vehicle on which inspection is overdue, operating an ineligible vehicle, operating a vehicle having an unpaid violation, operating a vehicle on which the operator information is not updated, operating a vehicle with an expired registration that was not renewed, and operating a vehicle housed in a state in which it is no longer registered. Operating a vehicle having legal compliance issues could potentially subject the vehicle to fines, affect the schedule of a vehicle if it is stopped for its legal compliance failure, and even possibly result in the seizure of a vehicle.

The legal status exception can be defined 210 to compare legal status information relating to each vehicle to data received 220 from each vehicle through the diagnostics server 30 concerning whether the vehicle is being used and the time it is being used. If the data from a vehicle indicates that the vehicle is being used at a time when the legal status information indicates that the vehicle is not in legal compliance as to an issue, application 230 of the exception will generate an exception.

In one embodiment, the legal compliance exceptions can be implemented by receiving data from a database having legal compliance information relating to each vehicle, which is used to define 210 the exception. Data relating to the vehicle is received 220 to determine whether the vehicle is being used, and data relating to the location of the vehicle may be received where the legal compliance exception is operating a vehicle in a state in which it is not registered. Significantly, in another embodiment, legal compliance exceptions can be advantageously implemented within an integrated system in which a fleet management system 90 containing legal status information is integrated with a diagnostic system that obtains data from which it can be determined that a vehicle is being used. In such a system, the fleet management system 90 would typically include all legal status information for each vehicle in the fleet. Thus, the fleet management system could include information on the date on which a vehicle's inspection expires, the dates when a vehicle is eligible for operation, whether a vehicle has a violation and the date on which it has to be paid, the date on which operator information should be updated, the date on which the vehicle's registration must be renewed, and the states in which a vehicle is eligible to operate. This data would be received by the processor 60 that is applying the legal compliance exception, which would compare the legal compliance information for each vehicle to the data obtained from the vehicle relating to whether the vehicle is being used, the date it is being used, and where it is being used. Data from the vehicle that indicates the vehicle is being used can include speed data that indicates that the vehicle is moving, odometer data that indicates that the vehicle is moving, ignition on information that indicates that the vehicle is on, or any other data that can be used to determine that the vehicle is in use.

Application of any of the exceptions can be programmed to occur at any processor 60 desired by the operator of the central station. The processor 60 can be in a computer, an application server, the data warehouse 50 server, or any other equipment with a processor 60 that is linked to the data warehouse 50. Application of any exception can be configured to occur at a time interval chosen by the operator of the central station. For example, the operator of the central station could configure the system to run the legal exceptions at periodic intervals, such as on a daily basis to ensure that the vehicle is being operated more safely over time. In another embodiment, the operator of the central station could configure the system to run the legal exceptions each time a vehicle is started, or each time the vehicle is moving (I approve this as documented) The configuration chosen can also depend on the configuration used on the diagnostics and location devices on the system or the processing required at the Central Station. Thus, if the configuration of the diagnostics system provides that diagnostics and location information is gathered only when a vehicle is started, it may be desirable to configure the exceptions to occur upon the start of a vehicle.

Notably, the categories of exceptions described herein are fluid, and any individual exception might fall under more than one category. For example, seat belt use exception can be categorized as a safety exception since it affects the safety of a vehicle operator, or it could be categorized as a legal compliance exception because in some areas seat belt use is a legal requirement. The fleet owner has the flexibility to determine which category a specific exception fits into, in a way that best allows the fleet owner to understand what types of undesired events are occurring and implement policies to stop those events from occurring. A fleet owner could implement other types of exceptions, such as exceptions relating to the following of specific fleet policies, without deviating from the spirit of the present invention.

After the exceptions for a vehicle have been determined, a statistical metric representing undesired use can be determined. Various methods of generating statistical metrics can be applied. For example, in one embodiment, the statistical metric is simply the number of exceptions generated for a vehicle, or the number of exceptions generated for each vehicle broken down by the category of the exceptions. In another embodiment, the statistical metric is the number of exceptions generated for a vehicle as compared to the total number of exceptions that could have been generated. In yet another embodiment, a statistical metric for exceptions is generated for a plurality or an entire fleet of vehicles, and the metric for each vehicle is compared against that metric. Each of these metrics allows a fleet owner to identify those vehicles on which there is higher number of undesired events as compared to the other vehicles in the fleet, which allows the fleet owner to take action to reduce the number of exceptions generated by those vehicles. Action that can be taken by a fleet owner based on the identification of a vehicle with a high number of exceptions includes adjustment of fleet policies, specialized training, and penalties for undesired use.

While the drawings and specific examples given describe exemplary embodiments of the present invention, they serve the purpose of illustration only. For example, the specific configuration of the diagnostic system and communication arrangement may differ depending on the work vehicle or platform or the mode of communication being used. The apparatus of the invention is not limited to the precise details and conditions disclosed. Furthermore, other substitutions, modifications, changes, and omissions may be made in the design, operating conditions, and arrangement of the preferred embodiments without departing from the spirit of the invention as expressed in the appended claims. A number of implementations have been described. Nevertheless, it will be understood that various modifications may be made. Accordingly, other implementations are within the scope of the following claims.

What is claimed is:

1. A method for assessing the undesired use of vehicles within a fleet, comprising:
defining at least one exception relating to the use of vehicles within the fleet, wherein the exception is selected from the group of safety exceptions, maintenance exceptions, legal compliance exceptions, and unauthorized use exceptions;
receiving data relating to the use of each vehicle within the fleet;
applying the at least one exception to the data for each vehicle and determining whether any defined exceptions have occurred;
determining a statistical metric representative of the undesired use of the vehicles within the fleet based upon the defined exceptions.

2. The method of claim 1, wherein the statistical metric comprises the percentage of vehicles within the fleet having either safety or maintenance exceptions over a predetermined period of time.

3. The method of claim 1, wherein the statistical metric comprises the percentage of safety, maintenance, legal compliance, and unauthorized use exceptions generated by all of the vehicles in the fleet out of the total number of safety, maintenance, legal compliance, and unauthorized use exceptions that could have been generated by all of the vehicles in the fleet.

4. The method of claim 1, wherein the statistical metric comprises the total number of safety, maintenance, legal compliance, and unauthorized use exceptions generated by each vehicle.

5. The method of claim 1, wherein if at least one exception is a safety exception, defining a safety exception comprises selecting a use condition relating to safety and defining a threshold value or a range of threshold values representing desired use.

6. The method of claim 5, wherein the use condition relating to safety is selected from the group of speed, acceleration, braking, seat belt usage, frequent lane changes, tailgating, speed relative to turns, and the occurrence of an accident.

7. The method of claim 6, wherein, if the use condition relating to safety is the occurrence of an accident, defining a threshold value or range of threshold values representing desired use comprises importing from a fleet management module information relating to the occurrence of an accident.

8. The method of claim 5, wherein determining whether safety exceptions have occurred comprises comparing the data relating to a use condition to the threshold value or range of threshold values representing a desired use condition, and generating an exception if the data does not match the threshold value or is not within the range of threshold values representing a desired use condition.

9. The method of claim 1, wherein if at least one exception is a maintenance exception, defining a maintenance exception comprises selecting a use condition relating to maintenance and defining a threshold value or a range of threshold values representing desired use.

10. The method of claim 9, wherein the use condition relating to maintenance is selected from the group of operating the vehicle while a warning indicator is on in the vehicle, operating the vehicle while a check engine light is on in the vehicle, and operating a vehicle for which scheduled maintenance is overdue.

11. The method of claim 10, wherein, if the use condition relating to maintenance is operating a vehicle for which a scheduled maintenance is overdue, defining a threshold value or a range of threshold values representing desired use comprises receiving data relating to the maintenance schedule for each vehicle within the fleet that indicates the time at which scheduled maintenance is due for each vehicle and whether that maintenance has been performed.

12. The method of claim 11, wherein receiving data relating to the maintenance schedule for each vehicle within the fleet comprises receiving maintenance schedule data generated by a scheduling module.

13. The method of claim 9, wherein determining whether maintenance exceptions have occurred comprises comparing the data relating to a use condition to the threshold value or range of threshold values representing a desired use condition, and generating an exception if the data does not match the threshold value or is not within the range of threshold values representing a desired use condition.

14. The method of claim 1, wherein if at least one exception is a legal compliance exception, defining a legal compliance exception comprises selecting a use condition relating to legal compliance and defining a threshold value or range of threshold values representing desired use.

15. The method of claim 14, wherein defining a threshold value or range of threshold values representing desired use comprises receiving data relating to the legal compliance of each vehicle within the fleet.

16. The method of claim 15, wherein receiving data relating to the legal compliance status of each vehicle within the fleet comprises receiving legal compliance data generated by a fleet management module.

17. The method of claim 14, wherein the use condition relating to legal compliance is selected from the group of operating a vehicle on which inspection is overdue, operating an ineligible vehicle, operating a vehicle having an unpaid violation, operating a vehicle on which the driver information is not updated, operating a vehicle with an expired registration that was not renewed, and operating a vehicle housed in a state in which it is no longer registered.

18. The method of claim 14, wherein determining whether legal compliance exceptions have occurred comprises comparing the data relating to a use condition to the threshold value or range of threshold values representing a desired use condition, and generating an exception if the data does not match the threshold value or is not within the range of threshold values representing a desired use condition.

19. The method of claim 1, wherein if at least one exception is an unauthorized use exception, defining an unauthorized use exception comprises selecting a use condition relating to unauthorized use and defining a threshold value or a range of threshold values representing desired use.

20. The method of claim 19, wherein the use condition relating to unauthorized use is selected from the group of operating a vehicle outside of an authorized time frame, and operating a vehicle outside of an authorized area.

21. The method of claim 20, wherein, if the use condition is operating a vehicle outside of an authorized time frame, defining a threshold value or a range of threshold values representing desired use comprises receiving data relating to the schedule for each vehicle within the fleet that indicates the times of authorized use.

22. The method of claim 21, wherein receiving data relating to the schedule for each vehicle within the fleet comprises receiving schedule data generated by a scheduling module.

23. The method of claim 20, wherein, if the use condition is operating a vehicle outside of an authorized area, defining a threshold value or a range of threshold values representing desired use comprises receiving location data for each vehicle and receiving data relating to the planned routes for each vehicle within the fleet that indicates the authorized routes for each vehicle.

24. The method of claim 23, wherein receiving data relating to the planned routes for each vehicle within the fleet comprises receiving planned route data generated by a routing module.

25. The method of claim 19, wherein determining whether unauthorized use exceptions have occurred comprises comparing the data relating to a use condition to the threshold range of values representing a desired use condition, and generating an exception if the data does not match the threshold value or is not within the range of threshold values representing a desired use condition.

26. The method of claim 1, wherein the data received relating to the use of each vehicle is processed data.

27. A method for assessing the undesired use of vehicles within a fleet, comprising:
defining at least one safety exception, one maintenance exception, and one unauthorized use exception relating to the use of vehicles within the fleet;
receiving data relating to the use of each vehicle within the fleet;
applying the at least one safety exception, one maintenance exception, and one unauthorized use exception to the data for each vehicle and determining whether any defined exceptions have occurred;
determining a statistical metric representative of the undesired use of the vehicles within the fleet based upon the defined exceptions.

28. The method of claim 27, wherein the statistical metric comprises the percentage of vehicles within the fleet having a safety, maintenance, or unauthorized use exception over a predetermined period of time.

29. The method of claim 27, wherein the statistical metric comprises the percentage of safety, maintenance, and unauthorized use exceptions generated by all of the vehicles in the fleet out of the total number of safety or maintenance exceptions that could have been generated by all of the vehicles in the fleet.

30. The method of claim 27, wherein the statistical metric comprises the total number of safety, maintenance, and unauthorized use exceptions generated by each vehicle.

31. The method of claim 27,
wherein the safety exception relating to the use of vehicles within the fleet is a speed safety exception relating to operation of a vehicle at an undesired speed;
wherein defining a speed safety exception comprises defining a threshold value or a range of threshold values representing desired use; and
wherein the data received relating to the use of each vehicle includes data relating to speed;
wherein determining whether the speed safety exception has occurred comprises comparing the data relating to the speed of each vehicle to the threshold value or range of threshold values representing a desired use condition, and generating an exception if the data does not match the threshold value or is not within the range of threshold values representing a desired use.

32. The method of claim 27,
wherein the maintenance exception relating to the use of vehicles within the fleet is a check engine light exception related to operation of the vehicle while a check engine light is on in the vehicle;
wherein defining the check engine light maintenance exception comprises defining a threshold value or a range of threshold values representing desired use;
wherein the data received relating to the use of a vehicle includes data relating to the status of the check engine light in each vehicle and data relating to when each vehicle was used; and
wherein determining whether the check engine light maintenance exception has occurred comprises comparing the data relating to use of each vehicle with the check engine light on to the threshold value or range of threshold values representing a desired use condition, and generating an exception if the data does not match the threshold value or is not within the range of threshold values representing a desired use.

33. The method of claim 27,
wherein the unauthorized use exception relating to the use of vehicles within the fleet is an unauthorized time use exception related to operation of the vehicle outside of an authorized time;
wherein defining the unauthorized time use exception comprises defining a threshold value or a range of threshold values representing desired use;
wherein the data received relating to the use of a vehicle includes data relating to the time when each vehicle was used; and
wherein determining whether the unauthorized time use exception has occurred comprises comparing the data relating to the time of use of the vehicle to the threshold value or range of threshold values representing a desired use, and generating an exception if the data does not match the threshold value or is not within the range of threshold values representing a desired use.

34. The method of claim 33, defining a threshold value or a range of threshold values representing desired use comprises receiving data relating to the schedule for each vehicle within the fleet that indicates the times of authorized use.

35. The method of claim 34, wherein receiving data relating to the schedule for each vehicle within the fleet comprises receiving schedule data generated by a scheduling module.

36. A system comprising:
a mobile device on a vehicle configured to obtain raw data relating to use conditions on a vehicle and wirelessly transmit that raw data to a diagnostics server, wherein the diagnostics server processes the raw data and creates processed data relating to use conditions;
a data warehouse server configured to receive the processed data from the first server;
a processor configured to apply at least one exception selected from the group of safety exceptions, maintenance exceptions, unauthorized use exceptions, and legal compliance exceptions to the processed data, and further configured to determine a statistical metric representative of the undesired use of the vehicles within the fleet based upon the application of the exceptions.

37. The system of claim 36, further comprising, if the processor is configured to apply a safety exception to the processed data relating to the occurrence of accidents,
a fleet management module having accident information for each vehicle in a fleet, wherein the fleet management module is configured to provide the data warehouse server with data relating to accidents for each vehicle in the fleet for use by the processor in defining the safety exception.

38. The system of claim 36, further comprising, if the processor is configured to apply a maintenance exception to the processed data relating to operation of a vehicle for which scheduled maintenance is overdue,
a scheduling module having maintenance schedule information for each vehicle in a fleet, wherein the scheduling module is configured to provide the data warehouse with data relating to the maintenance schedule information for each vehicle in the fleet for use by the processor in defining the maintenance exception.

39. The system of claim 36, further comprising, if the processor is configured to apply a legal compliance exception to the processed data relating to the legal status of each vehicle,
a fleet management module having legal status information for each vehicle in a fleet, wherein the fleet management module is configured to provide the data warehouse with data relating to the legal status information for each vehicle in the fleet for use by the processor in defining the legal compliance exception.

40. The system of claim 36, further comprising, if the processor is configured to apply an unauthorized use exception to the processed data relating to operation of a vehicle outside of an authorized time frame,
a scheduling module having schedule information indicating the authorized time or times of use for each vehicle in the fleet, wherein the scheduling module is configured to provide the data warehouse with data relating to the schedule information for each vehicle in the fleet for use by the processor in defining the unauthorized use exception.

41. The system of claim 36, further comprising, if the processor is configured to apply an unauthorized use exception to the processed data relating to operation of a vehicle outside of an authorized route,
a routing module having route information indicating the authorized route for each vehicle in the fleet, wherein the routing module is configured to provide the data warehouse with data relating to the authorized route for each vehicle in the fleet for use by the processor in defining the unauthorized use exception.

42. A system comprising:
a mobile device on a vehicle configured to obtain raw data relating to use conditions on a vehicle and wirelessly transmit that raw data to a diagnostics server, wherein the diagnostics server processes the raw data and creates processed data relating to use conditions;
a data warehouse configured to receive the processed data from the diagnostics server;
a processor configured to apply at least one safety exception, one maintenance exception, and one unauthorized use exception to the processed data, and further configured to determine a statistical metric representative of the undesired use of the vehicles within the fleet based upon the application of the exceptions; and
a scheduling module having schedule information indicating the authorized time or times of use for each vehicle in the fleet, wherein the scheduling module is configured to provide the data warehouse with data relating to the schedule information for each vehicle in the fleet for use by the processor in defining the unauthorized use exception.
